(19) United States
(12) Patent Application Publication
(10) Pub. No.: US 2004/0081593 A1
(43) Pub. Date: Apr. 29, 2004

(54) Reactor system for hydrogen production

(75) Inventors: Andreas Docter, Esslingen (DE); Marc Sommer, Ulm (DE); Norbert Wiesheu, Guenzburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/643,646

(22) Filed: Aug. 18, 2003

(30) Foreign Application Priority Data
Aug. 17, 2002 (DE) DE 102 37 744.8

(51) Int. Cl. B01D 53/34; F01N 3/10

(52) U.S. Cl. 422/173; 422/198; 422/190; 422/177

(57) ABSTRACT

A reactor system for producing hydrogen from a hydrocarbon or hydrocarbon derivative using autothermal reformation includes a mixture formation chamber, an autothermal reactor, and a temperature-regulated start-up burner. The start-up burner combusts the hydrocarbon or the hydrocarbon derivative with air so as to heat the mixture formation chamber and/or the autothermal reactor to a respective operating temperature. An air supply is metered to the start-up burner so as to regulate the temperature of hot gas coming out of the start-up burner to a value near or below a deterioration temperature of the catalyst material, before the hot gas contacts the mixture formation chamber and/or the autothermal reactor.

Priority is claimed to German patent application DE 102 37 744.8, the subject matter of which is hereby incorporated by reference herein.

The present invention relates to a reactor system for hydrogen production from a hydrocarbon or hydrocarbon derivative using autothermal reformation.

### BACKGROUND

In general, three methods are known for hydrogen production from liquid hydrocarbons or hydrocarbon derivatives.

First, there is steam reformation, in which water steam is converted into hydrogen-rich gas using a hydrocarbon or hydrocarbon derivative in an endothermic reaction on a catalyst with exclusion of oxygen.

Second, there is partial oxidation, which is run as a non-catalytic, exothermic process at temperatures from 1100° C. to 1500° C., it being possible to reduce the temperature if a catalyst is used.

Third, there is autothermal reformation, which is a combination of partial oxidation and steam reformation. In autothermal reformation, a part of the fuel is oxidized by controlled addition of oxygen in the presence of oxidation catalysts. The energy which is released during oxidation is necessary for the endothermic steam reformation taking place simultaneously. The temperature which results is between that of partial oxidation and that of steam reformation.

All of these methods share the feature that the conversion reaction—catalytic or not—requires a minimum temperature to which the reactor and possibly further components must be heated before the hydrogen production may begin, and/or at which they must be kept during operating pauses so that the hydrogen production may be resumed as rapidly as possible.

In particular for hydrogen production of mobile fuel cell systems, such as in fuel cell-driven motor vehicles, it is important that the energy necessary for heating the reactor is easily available with little storage capacity required.

A steam reformation facility is known from German Patent Application 19 754 013, in which the catalyst support having the catalyst is brought to operating temperature using electrical heating means.

There is even less need for mass and volume storage capacity if a start-up burner is used, in which the same hydrocarbon as the reactor uses, preferably a liquid hydrocarbon in fuel cell-driven motor vehicles, is combusted with air, the waste heat of the start-up burner being used to heat the reactor.

A start-up burner for a steam reformation facility is known from U.S. Pat. No. 4,473,622. The temperature of the hot gas flow of the start-up burner is regulated by the injection of water so that the catalyst is not overheated by the start-up burner and thus damaged.

A reactor system for autothermal reformation of a hydrocarbon or hydrocarbon derivative having a mixture formation chamber, an autothermal reactor, and a heater is known from German Patent Application 19 944 540.

### SUMMARY OF THE INVENTION

The present invention provides a reactor system for hydrogen production from a hydrocarbon or hydrocarbon derivative using autothermal reformation. The reactor system includes a mixture formation chamber for forming a mixture from the hydrocarbon or hydrocarbon derivative with water and air; an autothermal reactor, which contains a catalyst material, for simultaneous oxidation and steam reformation of the mixture; and a heater for heating the reactor system to operating temperature. The heater for heating the reactor system to operating temperature is a temperature-regulated start-up burner, in which the hydrocarbon or the hydrocarbon derivative is combusted with air. The temperature of the hot gas coming out of the start-up burner is regulated through metered supply of air to a value near or below the deterioration temperature of the catalyst material, before the hot gas is brought into contact with the reactor system.

The present invention allows the autothermal reactor and further components of the reactor system to be brought to operating temperature in an especially simple way which requires little mass, in that a start-up burner is used instead of an electric heater, whose hot gas flow temperature is not regulated through the injection of water, as is known from steam reformation, but rather using bypass air.

The hot gas flow of the start-up burner may be used to heat the reactor in various ways.

First, for indirect heating, by guiding the temperature-regulated hot gas flow in such a way that it heats the autothermal reactor without material contact with the catalyst material by conducting it into the space around the reactor system and having it heat these components from the outside. In this case, there is no danger of undesired oxidation effects in the reactor system, and the temperature regulation using bypass air has the additional effect that it increases the flow speed and therefore improves the heat transmission to the reactor components to be heated.

Second, the start-up burner may be used for direct heating of the reactor system by guiding the temperature-regulated hot gas flow into the main gas flow, which is conducted through the reaction chamber of the other thermal reactor, so that this chamber and the remaining components of the reactor system are heated very rapidly from the inside. Since the water produced by the combustion in the start-up burner may be used to initiate the reformation, the metering of water in the start-up phase of the reformation may also be reduced.

There are multiple possibilities for the arrangement of the start-up burner and the hot gas guiding for direct heating.

A preferred embodiment is to conduct the temperature-regulated hot gas flow of the start-up burner into the reaction chamber of the autothermal reactor via the mixture formation chamber, in particular through direct feeding into the mixture formation chamber, through which the reformation reaction may be started most rapidly.

Autothermal reactors, in particular those for fuel cell systems, are provided with a CO-removal device, which contains one or more shift steps, in which the carbon monoxide contained in the product gas of the reactor is converted into carbon dioxide and additional hydrogen. Between the reactor and the CO-removal device, the gas flow passes through a heat exchanger for heat exchange between the product gas of the autothermal reactor and the air which is supplied to the mixture formation chamber. In this case, a further preferred embodiment of the present invention is to feed the temperature-regulated hot gas flow into the part of the heat exchanger through which the air is conducted.

In all of the embodiments described above using direct heating of the autothermal reactor and the remaining components of the reactor system, the start-up burner may be operated using excess oxygen, which is not the case for the start-up burner of the steam reformation facility described in the aforementioned U.S. Pat. No. 4,473,622, which must be operated using a stoichiometric or lean fuel/air mixture, making the combustion unstable, making temperature regulation more difficult, and easily allowing undesired nitrogen oxides to arise.

In a preferred embodiment of the present invention, the start-up burner is incorporated into a housing in which the bypass air flows along the outside of the start-up burner and which contains a mixing zone for mixing the hot gas coming out of the start-up burner with the bypass air. In this way, the heat of the start-up burner is shielded in a simple way from the rest of the reactor system and stable temperature regulation is also made possible.

If a liquid hydrocarbon or liquid hydrocarbon derivative is used for the autothermal reformation, the liquid fuel additionally lowers the adiabatic combustion temperature of the start-up burner, as does the possible nearly instant vaporization of the educts, which also minimizes the production of nitrogen oxides during combustion. In addition, any nitrogen oxides may be removed through subsequent oxidation using hydrogen, which may also be produced very rapidly.

### BRIEF DESCRIPTION OF THE DRAWINGS

The present invention is elaborated upon below based on exemplary embodiments with reference to the drawings.

FIG. 1 shows a schematic diagram of an exemplary embodiment of an autothermal reactor system having indirect heating.

FIG. 2 shows a schematic diagram of an exemplary embodiment of an autothermal reactor system having direct heating.

FIG. 3 shows a schematic diagram of a further exemplary embodiment of an autothermal reactor system having direct heating.

FIG. 4 shows an enlarged schematic diagram of the start-up burner used in the exemplary embodiments.

### DETAILED DESCRIPTION

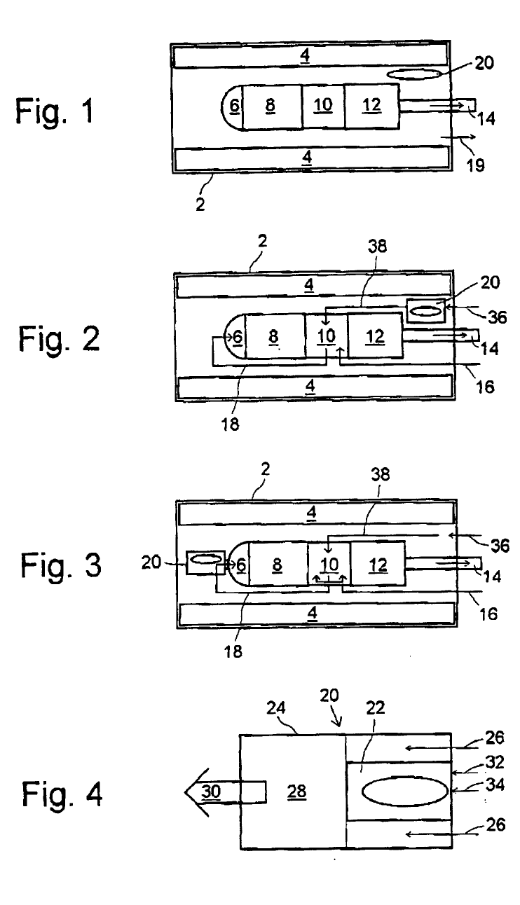

In FIGS. 1 through 3, an autothermal reactor system is built into a housing 2 which is provided with heat insulation 4. The reactor system includes, in order, a mixture formation chamber 6, an autothermal reactor 8, a high-temperature heat exchanger 10, one or more shift steps 12, and a reformation gas outlet 14.

Mixture formation chamber 6 is set up for the purpose of mixing the educts supplied thereto for autothermal reformation, specifically liquid hydrocarbon, water, and air, in a specific ratio to one another and supplying the educt mixture to autothermal reactor 8, as is described in German Patent Application 100 21 815, for example.

Autothermal reactor 8 contains support elements, not shown, which are provided with a catalyst material. When the educt mixture flows through autothermal reactor 8 during operation, a part of the hydrocarbon is oxidized by air oxygen at a specific temperature, the energy released upon oxidation being just sufficient for a conversion of hydrocarbon and water into a hydrogen-rich gas to occur simultaneously.

The product gas of autothermal reactor 8 is conducted through high-temperature heat exchanger 10 into shift step 12, in which the carbon monoxide contained in the product gas, which would be harmful for a fuel cell system connected downstream from the reactor system, is largely converted into carbon dioxide and additional hydrogen through a shift reaction with water. The hydrogen-rich and sufficiently carbon monoxide-poor product gas is available at outlet 14 of shift step 12 as a reformation gas.

Between autothermal reactor 8 and shift step 12, the product gas of autothermal reactor 8 passes through high-temperature heat exchanger 10, in which heat exchange occurs with air 16 supplied from the outside (FIGS. 2 and 3), the air heated in this way being supplied as one of the educts to mixture formation chamber 6 via a line 18, as is indicated in FIGS. 2 and 3 by arrows. The remaining educts, specifically water and hydrocarbon, may be conducted, together with the air, through high-temperature heat exchanger 10 in order to preheat and vaporize them. Simultaneously, the product gas of autothermal reactor 8 is cooled in high-temperature heat exchanger 10 before it enters shift step 12.

Autothermal reformation requires a minimum temperature to which the reactor and possibly further components must be heated before the hydrogen production may begin, and/or at which they must be kept during operating pauses, so that the hydrogen production may be resumed as rapidly as possible.

In order to reach this minimum temperature rapidly and using little energy storage outlay for mass and volume, the reactor system in the exemplary embodiment of FIG. 1 contains a start-up burner 20 which is shown rather schematically in FIG. 1. In the exemplary embodiment of FIG. 1, the parts of the reactor system to be heated are heated from the outside by the hot gas produced by start-up burner 20, in order to bring them to the operating temperature. After it has given up part of its heat to the reactor system, the hot gas of start-up burner 20 is conducted out of housing 2 as exhaust gas 19. When the reactor system has reached its operating temperature, the educts are supplied, and when the autothermal reformation has begun, start-up burner 20 is switched off.

The hot gas flow of start-up burner 20 has its temperature regulated using metered supply of bypass air so that the catalyst materials in the reactor system are not overheated by start-up burner 20 and therefore damaged. This may be performed in an encapsulated start-up burner 20, for example, as is schematically shown in FIG. 4.

In FIG. 4, actual burner 22 is built into a burner housing 24, in which bypass air 26 flows along the outside of burner 22 before it enters a mixing zone 28 together with the hot gas coming out of burner 22. In mixing zone 28, bypass air 26 is mixed as homogeneously as possible with the hot gas in order to exit as temperature-regulated hot gas flow 30 and heat the reactor system. The temperature is regulated through appropriate metering of supplied bypass air 26 and, if necessary, additionally through suitable metering of air 32 and fuel 34 (hydrocarbon), which are supplied to burner 22.

The reactor system may be brought to the operating temperature using direct heating, as shown in FIGS. 2 and 3, instead of using indirect heating, as shown in FIG. 1.

In the exemplary embodiment of FIG. 2, start-up burner 20 is built into housing 2 and produces a hot gas flow from educts 36 (air and fuel) supplied to it, which is introduced via a pipeline 38 into the part of high-temperature heat exchanger 10 through which air 16 flows during reforming operation. Therefore, in the starting phase, hot gas flow 30 is guided in sequence through the air part of high-temperature heat exchanger 10, mixture formation chamber 6, autothermal reactor 8, the product gas part of high-temperature heat exchanger 10, and shift step 12 to reformation gas outlet 14, these parts being heated in sequence.

For perfect oxidation in start-up burner 20, i.e., combustion at a stable temperature and low in harmful materials, the burner is operated using at least a stoichiometric fuel/air mixture, i.e., an air lambda of 1.0, and preferably using excess oxygen, an air lambda of 1.2, for example.

In each case, hot gas flow 30 entering autothermal reactor 8 contains oxygen, at least the oxygen contained in the bypass air. Therefore, oxygen comes out of autothermal reactor 8 in the heating phase. This is harmless if the catalyst material in shift step 12 is a noble metal, which may come into contact with oxygen without problems. Therefore, a shift step 12 having a noble metal catalyst is used for the directly heated exemplary embodiments.

As soon as the reactor system has reached its operating temperature, start-up burner 20 is switched off and mixture formation chamber 6 is supplied with the correct educt mixture for the autothermal reformation. At this point in time, the oxygen content of the educt flow must be tailored exactly to the quantity of water steam and hydrocarbon provided, since the reformation occurs hypostoichometrically. Therefore, it may be necessary to reduce the quantity of air 16 supplied from the outside by the quantity of oxygen contained in hot gas flow 30, at least toward the end of the heating of the reactor system, so that the appropriate quantity of educts enters autothermal reactor 8 at the correct point in time to start the autothermal reformation.

In general, this means that for direct heating of the reactor system, the air-stoichiometric excess of oxygen is to be considered; oxygen must be included in the regulation of the air flow for the reformation, and the temperature of hot gas flow 30 must, of course, be regulated down using bypass air 26 only enough so that the oxygen content does not cause any undesired oxidation reactions.

The exemplary embodiment of FIG. 2 has the advantage that after reaching the operating temperature, excess water may be used immediately, since the water steam is not able to condense out in already heated high-temperature heat exchanger 10. If separate air is supplied directly before shift step 12 or the possible multiple shift steps, oxidation may be performed directly in the shift step using this air oxygen and the reformed hydrogen, which may be controlled with the aid of the entrained water.

The exemplary embodiment of FIG. 3 differs from the exemplary embodiment of FIG. 2 in that start-up burner 20 is positioned directly before mixture formation chamber 6, and its hot gas flow is conducted, together with educts 16 and 36, out of line 18 into mixture formation chamber 6. In this way, the reformation reaction may be started especially rapidly. The thermal energy first heats mixture formation chamber 6 and immediately afterward autothermal reactor 8, which may then offer a hydrogen-rich gas very rapidly.

If high-temperature heat exchanger 10 is provided with certain catalytic properties, such as a partial coating made of platinum, and oxygen is conducted into high-temperature heat exchanger 10, in the exemplary embodiment of FIG. 3, even hydrogen produced in the start-up phase may be combusted. In this way, not only does additional combustion heat arise for further heating of high-temperature heat exchanger 10 and/or shift step 12, but nitrogen oxides, which are present in hot gas flow 30 due to the combustion in the start-up burner, are also removed.

What is claimed is:

1. A reactor system for producing hydrogen from a hydrocarbon or hydrocarbon derivative using autothermal reformation, comprising:
a mixture formation chamber configured to form a mixture of the hydrocarbon or hydrocarbon derivative with water and air;
an autothermal reactor configured for simultaneous oxidation and steam reformation of the mixture, the autothermal reactor including a catalyst material; and
a temperature-regulated start-up burner configured to combust the hydrocarbon or hydrocarbon derivative with air so as to heat at least one of the mixture formation chamber and the autothermal reactor to a respective operating temperature, and configured to meter an air supply so as to regulate a temperature of hot gas coming out of the start-up burner to a value near or below a deterioration temperature of the catalyst material, before the hot gas contacts the at least one of the mixture formation chamber and the autothermal reactor.

2. The reactor system as recited in claim 1 wherein a flow of the hot gas is guided so that the hot gas heats the autothermal reactor without material contact with the catalyst material.

3. The reactor system as recited in claim 1 wherein a flow of the hot gas is guided into a reaction chamber of the autothermal reactor.

4. The reactor system as recited in claim 3 wherein the flow of the hot gas is guided into the reaction chamber via the mixture formation chamber.

5. The reactor system as recited in claim 4 wherein the flow of the hot gas is fed directly into the mixture formation chamber.

6. The reactor system as recited in claim 4 further comprising a heat exchanger configured to exchange heat between a product gas of the autothermal reactor and air supplied to the mixture formation chamber, and wherein the flow of the hot gas is fed into a part of the heat exchanger through which the air is conducted.

7. The reactor system as recited in claim 1 wherein the start-up burner is configured to be operated using excess oxygen.

8. The reactor system as recited in claim 1 wherein the start-up burner includes a housing and a burner disposed in the housing and configured for bypass air to flow between the housing and the burner, the housing including a mixing zone configured to mix hot gas coming out of the burner with the bypass air.

9. The reactor system as recited in claim 1 wherein the hydrocarbon or hydrocarbon derivative is liquid at room temperature.

10. The reactor system as recited in claim 1 wherein the reactor system is disposed in a fuel cell-driven motor vehicle.
